(19) United States
(12) Patent Application Publication
(10) Pub. No.: US 2001/0031811 A1
(43) Pub. Date: Oct. 18, 2001

(54) Durable coating composition, process for producing durable, antireflective coatings, and coated articles

(76) Inventors: Huawen Li, Delmont, PA (US); Bhima R. Vijayendran, Monroeville, PA (US)

Correspondence Address: P P G INDUSTRIES, INC., ONE P P G PLACE, PITTSBURGH, PA, 15272, US

(21) Appl. No.: 09/795,619

(22) Filed: Feb. 28, 2001

Related U.S. Application Data
(62) Division of application No. 08/585,617, filed on Jan. 16, 1996.
Application No. 08/585,617 is a continuation-in-part of application No. 08/165,996, filed on Dec. 13, 1993, now abandoned.

(51) Int. Cl. C08K 5/24

(52) U.S. Cl. 524/262; 524/379; 524/459; 524/535; 524/803

(57) ABSTRACT

Describes durable coating compositions and a process for the preparation of durable, broad-band antireflective coatings on organic polymeric host materials and photochromic organic polymeric host materials. The coating compositions consist essentially of a silane monomer mixture comprising glycidoxyalkylalkoxysilane and alkylalkoxysilane(s) with or without tetraalkoxysilanes; water-soluble organic polymer; a leveling amount of nonionic surfactant; a solvating amount of lower aliphatic alcohol; a catalytic amount of water-soluble acid; and water. The coating compositions may optionally contain fluorinated silane(s). Also describes a process for preparing antireflective coatings comprising the steps of coating a polymeric host material with the durable coating composition; curing the coating; treating the cured coating with an aqueous acidic solution to produce a graded refractive index; removing residual acid; and further curing the coating.

### CROSS REFERENCE TO RELATED APPLICATION

This application is a continuation-in-part application of U.S. patent application Ser. No. 08/165,996 filed Dec. 13, 1993.

### DESCRIPTION OF THE INVENTION

The present invention relates to novel durable coating compositions. More particularly, the present invention relates to a novel process that utilizes a durable coating to form a single-layer, durable, broad band antireflective coating on an organic polymeric host material. Still more particularly, this invention relates to articles such as optical elements, e.g., ophthalmic lenses, transparent sheets, films and photochromic articles, such as photochromic optical elements, transparent sheets and films, having on at least one surface thereof, a durable optically transparent coating of the present invention, or a durable, antireflective optically transparent coating formed by the process of the present invention.

Organic polymeric host material(s) that are typically used to make optical elements, transparent sheets and films, have surfaces that are susceptible to abrasion and chemical attack. Often, such materials are coated with a protective coating to improve their abrasion resistance.

Abrasion resistant coatings that incorporate polyvinyl alcohol or hydrolyzed polyvinyl acetate and acid polysilicic acid ester, hydrolyzed polysilicic acid ester or hydrolyzed metal lower alkoxide have been described in U.S. Pat. Nos. 2,404,426; 3,652,379; 3,971,872; 3,998,991; 4,120,992; 4,423,131; and 5,037,871. Abrasion resistant coatings incorporating hydrolyzed polysilicic acid esters and polyvinyl acetals having a hydroxyl group content of 35 to 50 weight percent, calculated as polyvinyl alcohol, are described in U.S. Pat. Nos. 4,164,602 and 4,172,187. The use of polyvinyl pyrolidone with organoalkoxysilane to form siloxane organic hybrid polymers is described in U.S. Pat. No. 5,115,023. Other protective coatings formed from a partial condensate of a silanol or an organic silicone compound (or its hydrolysate) and particulate matter such as colloidal silica or micron-sized diamonds are described in U.S. Pat. No. 3,986,997 and Japanese Patent Application 3-21678, respectively.

In U.S. Pat. No. 4,127,697, an improvement in the adhesion of the abrasion resistant coating described in U.S. Pat. No. 3,986,997 to a lens, is obtained by treating the lens with a tie-coat comprising an A-alkylenealkoxysilane, wherein A contains a group reactive with the substrate. Japanese Patent Application 62-212490 describes a coating comprising composites made of methyltrimethoxysilane and other organic silicones. This coating is used to control the rate of discoloration of organic photochromic viologen compounds that have been incorporated into a soluble resin, such as polyvinyl alcohol.

Photochromism is a reversible phenomenon exhibited by a compound which, when exposed to light radiation involving ultraviolet rays, such as the ultraviolet radiation in sunlight or in the light of a mercury lamp, changes color and then returns to its original color after the ultraviolet radiation is discontinued or the compound is stored in the dark. Various classes of photochromic compounds have been synthesized and suggested for use in applications in which a sunlight-induced reversible color, change or darkening is desired. For example, spiro(indoline)pyridobenzoxazine photochromic compounds are described in U.S. Pat. No. 4,637,698. Spiro(indoline)naphthoxazines are described in U.S. Pat. Nos. 3,562,172; 3,578,602; 4,215,010 and 4,342,668. Benzopyrans and naphthopyrans having a nitrogen-containing substituent at the 2-position of the pyran ring are described in U.S. Pat. No. 4,818,096. All of the aforedescribed oxazine- and pyran-type organic photochromic compounds are reported to exhibit a color change of from colorless to purple/blue on exposure to a source of ultraviolet (UV) light, e.g., sunlight.

Other organic photochromic compounds are reported to exhibit a color change of from colorless to yellow/orange when exposed to a source of UV light. Examples of such organic photochromic compounds are benzopyrans and naphthopyrans having a spiro adamantane group at the 2-position of the pyran ring. These spiropyrans are described in U.S. Pat. No. 5,826,977. Other yellow/orange coloring organic photochromic compounds include the naphthopyran compounds described in U.S. Pat. No. 5,066,818. These compounds contain at least one ortho-substituted phenyl substituent at the 3-position of the pyran ring, preferably a monoortho-substituted phenyl substituent.

As reported in the literature, a major market demand for photochromic ophthalmic lenses are for those that darken to a brown or gray color. See, for example, U.S. Pat. No. 4,818,096 (column 2, lines 35-45). In order to achieve such a near neutral coloring of an article, blending of one organic photochromic substance having an absorption maximum within the range of between greater than 590 and about 700 nanometers and another organic photochromic substance exhibiting at least one absorption maximum and preferably two absorption maxima, within the range of between about 400 and less than 500 nanometers has been described in U.S. Pat. No. 4,968,454.

Antireflective coatings on ophthalmic lenses have become very desirable for consumers in various world markets. The advantages of such coatings, as reported by K. H. Guenther in Thin Film Coating Technology for Ophthalmic Lenses, SPIE, 601, Ophthalmic Optics, 1985, pages 76-87, are the elimination of ghost images due to multiple internal reflections and of disturbing reflection to the wearer and the external viewer. As a consequence, the aesthetic-cosmetic benefit to the wearer is that he or she not only sees better, but also looks better.

The use of a single layer to form antireflective coatings to reduce reflection losses and increase the transmission of optical glass and plastic systems is described in U.S. Pat. Nos. 5,116,644 and 5,198,267, and European Patent 0402473. The use of a two- or three-layered coating to produce antireflective surfaces has been described in U.S. Pat. Nos. 5,104,692 and 5,173,368. In most cases, an antireflective surface is prepared on an optical article by first coating the article with a hard coat and then applying the antireflective layer, as described in U.S. Pat. No. 4,904,525 and Japanese Patent Application 60-88901. U.S. Pat. No. 5,116,664 describes an antireflective layer formed by coating a lens with a siloxane-containing hard coat solution having at least one oxide sol, hardening the coated solution to give a hard coat layer, and immersing the lens into an acidic or alkaline solution to dissolve the oxide particles contained in the hard coat layer so as to make the layer non-uniform.

Antireflective coatings formed by the dissolution of coating components using various acids and bases may undergo further dissolution during use of the coated article if it is exposed to acid rain or alkaline cleaning agents. Formation of antireflective coatings using vacuum deposition requires costly equipment and precise control to meet exacting specifications. Consequently, there is a need for a cost effective process to produce durable, antireflective coatings.

It has now been discovered that treatment of a durable transparent coating (hard coat) by the novel process of the present invention can produce a single-layer, durable, transparent adherent antireflective coating on an organic polymeric host material. When the process of the present invention is used to treat photochromic articles coated with the novel coating composition of the present invention, there is provided the additional benefit of extended longevity of the organic photochromic substances used to achieve the photochromic effect.

The novel coating compositions of the present invention consist essentially of a mixture of certain organoalkoxysilane monomers, with or without tetraalkoxysilanes, water-soluble polymer, nonionic surfactant(s), lower aliphatic alcohol solvent, water-soluble acid, and water. Fluorinated silane(s) may also be present in the coating compositions.

These compositions may be used to produce a single-layer, sol-gel, i.e., solution/gelation, durable, i.e., resistant to abrasion and chemicals, adherent, cured coating on organic polymeric host materials using conventional coating technology. The coating compositions of the present invention are substantially free of colloidal oxide sols, diamond particles and the crosslinking agents formaldehyde and zirconyl nitrate.

The novel process of the present invention comprises forming a durable cured coating from either the aforesaid novel coating composition or from coating compositions known in the art to produce a durable, optically clear, cured coating, and treating said cured coating to produce a coating having a graded porosity. More particularly, the process of the present invention comprises (a) treating the durable cured coating with hydrofluoric acid, with or without nitric acid, thereby to form a coating with graded porosity, i.e., a coating the porosity of which decreases from a point at the surface of the coating to a point adjacent to the surface of the coated article, thereby providing a coated article with a refractive index gradient, (b) leaching acid from the surface of the treated coating with an aqueous alkaline agent, and (c) further curing the treated coating.

Transparent articles having a protective hard coating treated in accordance with the process of the present invention have a visible light transmission of greater than about 95 percent with not more than about 0.5 percent haze. Also, such articles are antireflective over a broad range of the visible spectrum, i.e., 400 nanometers to 700 nanometers. Photochromic articles coated with the novel durable coating composition of the present invention and then treating the resultant coating treated in accordance with the process of the present invention have less loss of photochromic performance compared to photochromic articles having a commercially available antireflective coating applied to the article by vacuum deposition.

### DETAILED DESCRIPTION OF THE INVENTION

The use of polyvinyl pyrolidone, polyvinyl alcohol, or hydrolyzed polyvinyl acetate, in combination with organoalkoxysilanes, hydrolyzed polysilicic acid ester, or hydrolyzed metal lower alkoxide in protective coating compositions has been described. Specifically, U.S. Pat. No. 5,115,023 describes an abrasion resistant coating made by a condensation polymerization reaction of an organoalkoxysilane in the presence of polyvinyl pyrrolidone; U.S. Pat. No. 3,998,991 describes a coating composition that includes a trialkoxysilane that has epoxy functionality in combination with tetraalkoxysilane; and U.S. Pat. Nos. 3,971,872 and 4,120,992 claim a polysilicic acid ester of an alcohol containing from 1 to 12 carbon atoms, said ester having up to four silicic acid groups per silicon atom. The ′992 patent includes a cross-linking agent, such as formaldehyde or zirconyl nitrate in the formulation. U.S. Pat. No. 4,423,131 describes an improved photoresponsive device containing as a protectant overcoating a top layer of a crosslinked polyvinylsilicate resulting from the reaction of polysilicic acid with a polyvinyl alcohol having a number average molecular weight of from 10,000 to about 100,000. The polysilicic acid component of the overcoating can be altered by the hydrolysis of trialkoxysilanes or the cohydrolysis of a trialkoxysilane and a tetraalkoxysilane. U.S. Pat. No. 5,037,872 describes a protective overcoat composition and photographic elements containing same comprising (a) a water-soluble hydroxylated polymer, (b) hydrolyzed metal lower alkoxide or mixtures of such alkoxides, and (c) a fluoroalkyl polyether surfactant.

The process of forming a protective hard coating on a substrate and treating the coating to provide an antireflective layer has been described. U.S. Pat. No. 5,116,644 describes coating a plastic lens with a coating solution containing at least one colloidal oxide sol, silane coupling agent and epoxy resin; hardening the coating; and immersing it in an aqueous solution of acidic or alkaline substance to dissolve the oxide particles in the hardcoat so that the refractive index of the coating in the direction of the thickness of the layer varies.

Other than in the operating examples, or where otherwise indicated, all numbers expressing quantities of ingredients or reaction conditions used herein are to be understood as modified in all instances by the term “about”. In each instance where the term “weight percent” is used herein with respect to the coating composition, it is to be understood that the described weight percent is based on the total weight of the coating composition.

The coating composition of the present invention, containing tetraalkoxysilane, is an aqueous composition consisting essentially of from about 20 to about 70 weight percent, preferably 20 to 55 weight percent, and more preferably 20 to 45 weight percent, of a silane monomer mixture (and hydrolysates thereof). The silane monomer mixture comprises (i) a first silane monomer which is a glycidoxy(C₁-C₃)alkyl(C₁-C₂)ₐ alkyl(C₁-C₂)_{b} alkoxysilane monomer, wherein a is an integer selected from the group consisting of 0, 1, and 2 and b is an integer selected from the group consisting of 2 and 3, provided that b is 3 only when a is 0 or 1, and (ii) a second silane monomer having the general formula (X)_{c}(C₁-C₃)_{d} alkyl(C₁-C₃)ₑ alkyl(R¹)_{f}Si_{4-(d+e+f)}, wherein X is selected from the group consisting of mercapto, amino, chloro, and methacryloxy, R¹ is C₁-C₄ alkoxy or acetoxy, c and d are each the integers 0 or 1, e is the integer 1 or 2, and f is the integer 2 or 3, provided that the sum of d, e, and f is not greater than 4. The weight ratio in the silane monomer mixture of the first silane monomer to the second silane monomer may vary from about 1:3 to 1:20, preferably from about 1:4 to 1:15, and more preferably from about 1:7 to 1:10.

The other coating composition of the present invention is identical to the aforementioned coating composition except that it is substantially free of tetraalkoxysilane and the weight ratio of the first silane monomer to the second silane monomer is from 1:7 to 1:15, and preferably from 1:7 to 1:10.

Suitable silane monomers that may be used as the first silane monomer include glycidoxymethyltriethoxysilane, alpha-glycidoxyethyltrimethoxysilane, alpha-glycidoxyethyl-triethoxysilane, beta-glycidoxyethyltrimethoxysilane, beta-glycidoxyethyltriethoxysilane, alpha-glycidoxy-propyltrimethoxysilane, alpha-glycidoxypropyltriethoxysilane, beta-glycidoxypropyltrimethoxysilane, beta-glycidoxypropyl-triethoxysilane, gamma-glycidoxypropyltrimethoxysilane, gamma-glycidoxypropylmethyldimethoxysilane, gamma-glycidoxy-propyldimethylethoxysilane, hydrolysates thereof, and mixtures of such silane monomers. Preferably, the first silane monomer is selected from the group consisting of gamma-glycidoxy-propyltrimethoxysilane, gamma-glycidoxypropylmethyldimethoxy-silane, and gamma-glycidoxypropyldimethylethoxysilane, and more preferably is gamma-glycidoxypropyltrimethoxysilane.

Suitable silane monomers that may be used as the second silane monomer include methyltrimethoxysilane, methyl-triethoxysilane, methyltri-acetoxysilane, methyltripropoxysilane, methyltributoxysilane, ethyltrimethoxysilane, ethyltriethoxysilane, gamma-meth-acryloxypropyltrimethoxysilane, gamma-aminopropyltri-methoxysilane, gamma-aminopropyltriethoxysilane, gamma-mer-captopropyltrimethoxysilane, chloromethyltrimethoxysilane, chloromethytriethoxysilane, dimethyldiethoxysilane, gamma-chloropropylmethyldimethoxysilane, gamma-chloropropyl-methyldiethoxysilane, hydrolysates thereof, and mixtures of such silane monomers. Preferably, the second silane monomer is selected from the group consisting of methyltrimethoxy-silane, methyltriethoxysilane, ethyltrimethoxysilane, and ethyltriethoxysilane, and more preferably it is methyltri-methoxysilane.

Tetra(C₁-C₄)alkoxysilanes, when present in the coating composition, are present at a level of from about 1 to 40 weight percent, preferably 2 to 20 weight percent and more preferably, from 2 to 10 weight percent. Suitable compounds include tetramethoxysilane, tetraethoxysilane, tetra-n-propoxysilane, tetra-n-butoxysilane, hydrolysates thereof, and mixtures of such silane monomers. Preferably, tetraethoxysilane is used.

The coating composition containing tetraalkoxysilane and having the preferred weight ratio of the first to the second silane monomer of from 1:4 to 1:15, as well as the tetraalkoxysilane-free coating composition of the present invention, may also contain from about 1 to about 10, preferably 1 to 5, weight percent of fluorinated silane. The fluorinated silane may be selected from the group consisting of trifluoroacetoxypropyl tri(C₁-C₂)alkoxysilanes; 3-(heptafluoroisopropoxy)propyltrichlorosilane; 3-(heptafluoroisopropoxy)propyltriethoxysilane; N-(3-triethoxysilylpropyl)perfluorooctanoamide; N-(3-triethoxysilylpropyl)perfluoro(2,5-dimethyl-3,6-diox-anonanoyl)amide and substances corresponding to the general formula: F(CF₂)_{g}CH₂CH₂Si(CH₃)ₕ^{Z}₃₋ₕ, wherein Z is chloro, methoxy or ethoxy, g is an integer selected from the integers 1 to 10, and h is the integer 0, 1 or 2.

The preferred fluorinated silane(s) are those substances having the general formula: F(CF₂)_{g}CH₂CH₂Si(CH₃)ₕZ₃₋ₕ. Such substances include tridecafluoro-1,1,2,2-tetrahydrooctyl-1-dimethylchlorosilane, tridecafluoro-1,1,2,2-tetrahydrooctyl-1-methyldichlorosilane, tridecafluoro-1,1,2,2-tetrahydro-octyl-1-trichlorosilane, tridecafluoro-1,1,2,2-tetrahydro-octyl-1-triethoxysilane, 3,3,3-trifluoropropyldimethyl-chlorosilane, 3,3,3-trifluoropropylmethydichlorosilane, 3,3,3-trifluoropropylmethyldimethoxysilane, 3,3,3-tri-fluoropropylmethyldimethoxysilane, 3,3,3-trifluoro-propyltrichlorosilane, 3,3,3-trifluoropropyltrimethoxysilane, 1H, 1H, 2H, 2H-perfluoroalkyltriethoxysilane, 1H, 1H, 2H, 2H-perfluorodecyldimethylchlorosilane, 1H, 1H, 2H, 2H-perfluorodecylmethyldichlorosilane, 1H, 1H, 2H, 2H-perfluoro-trichlorosilane, 1H, 1H, 2H, 2H-perfluorotriethoxysilane, 1H, 1H, 2H, 2H-perfluorooctylmethyldichlorosilane, 1H, 1H, 2H, 2H-perfluorooctyltrichlorosilane, and 1H, 1H, 2H, 2H-perfluoro-octyltriethoxysilane. The most preferred fluorinated silane is 3,3,3-trifluoropropyltrimethoxysilane.

Water-soluble organic polymer is present in the coating composition in amounts sufficient to bind and form the coating or film resulting from polycondensation of the various silane components of the coating composition, i.e., a binding amount, which typically is at a level of from about 1 to about 8 weight percent, preferably 1 to 6 weight percent. Suitable water-soluble polymers are those polymers that have a solubility in water of at least about 1 to 10 weight percent at 25° C. Additionally, the water-soluble polymers are chemically compatible with the silane monomers in the coating composition, i.e., capable of forming siloxane organic hybrid polymers, are optically clear and mechanically strong, i.e., provide sufficient mechanical strength and integrity to the porous coating.

Water-soluble polymers that may be used include natural gums such as guar gums, locust bean gums, and xanthan gums; hydroxyalkylcelluloses such as hydroxyethylcellulose and hydroxypropylcellulose, the synthesis and structure of which are described in U.S. Pat. Nos. Nos. 3,278,521 and 4,661,589, which are herein incorporated by reference; cellulosic polymers such as carboxymethyl cellulose, methyl cellulose, and ethylmethyl cellulose; polyvinyls, polyvinyl maleic anhydride copolymers, polyvinyl alcohols, copolymers of polyvinyl alcohol and polyvinyl amine having up to 30 weight percent of polyvinyl amine, polyvinylamines, and polyvinyl pyrrolidones; polyacrylates and related systems such as polyacrylic acids, polymethacrylic acids, polyacrylamides, polycarboxylates, and polyvinyl ethyl ether; polyimines and related systems such as polyethylenimine, polyethylene oxides, polyethylene glycols and mixtures of such water-soluble polymers.

The preferred water-soluble polymers are polyvinyl alcohol, hydroxyethylcellulose and polyvinyl pyrrolidone. Suitable polyvinyl alcohols range in number average molecular weight from 3,000 to 150,000 and range from 72 to greater than 99 percent hydrolyzed, preferably at least 87 percent hydrolyzed. Suitable hydroxyethylcelluose polymers range in number average molecular weight from 9,000 to 1,300,000 and range in molar substitution from 1.5 to 3.5 as described in the Kirk-Othmer Encyclopedia of Chemical Technology, 4th Edition, Volume 5, John Wiley and Sons, N.Y. (1993), pages 548 to 551, the disclosure of which is herein incorporated by reference. Molar substitutions greater than or equal to 1.5 produce a water-soluble hydroxyethylcellulose. Suitable polyvinyl pyrrolidones range in number average molecular weight from 10,000 to 360,000 and are described in the Kirk-Othmer Encyclopedia of Chemical Technology, 3rd edition, Volume 23, pages 967 to 979, the disclosure of which is herein incorporated by reference. The water solubility of polyvinyl pyrrolidone is limited only by the viscosity of the resulting solution.

A leveling amount of nonionic surfactant(s) is present as a component in the coating composition. A leveling amount is that amount which is sufficient to allow the coating to spread evenly or to level the coating composition on the surface of the organic polymeric host material to which it is applied, and provide uniform contact of the coating to the surface of the host material. Preferably, the nonionic surfactant is a liquid at the conditions of use and is used in amounts from about 0.05 to about 1.0 weight percent based on the amount of the silane monomer mixture. Suitable nonionic surfactants are described in the Kirk Othmer Encyclopedia of Chemical Technology, 3rd Edition, Volume 22, pages 360 to 377, the disclosure of which is incorporated herein by reference.

More particularly, the nonionic surfactant may be selected from the group consisting of ethoxylates of primary, secondary and branched paraffinic alcohols wherein the alcohol contains from about 6 to 20 carbon atoms and the average number of ethoxy groups are from 1 to 20; alkyl phenol ethoxylates and dialkyl phenol ethoxylates wherein each of the alkyl substituents contains from about 6 to about 12 carbon atoms and the average number of ethoxy groups are from 1 to 24; benzyl, propyleneoxy, butyleneoxy, phenoxy and C₁-C₄ alkoxy capped alkyl phenol ethoxylates, wherein the average number of propyleneoxy or butyleneoxy groups is from 1 to 5; glycerol esters of fatty acids containing from 6 to 24 carbon atoms; ethoxylates and propoxylates of fatty acids wherein the fatty acids contain from 6 to 24 carbon atoms and the average number of ethoxy or propoxy groups is from 1 to 24; sorbitan fatty acid esters wherein the fatty acids contain from 6 to 24 carbon atoms and ethoxylated sorbitan fatty acids esters wherein the average number of ethoxy groups is from about 3 to 20; fatty acid alkanolamides, such as fatty acid diethanoloamides, where the fatty acid contains from 6 to 24 carbon atoms and the alkanolamide contains from 0 to 4 carbon atoms; amine ethoxylates such as tertiary amine ethoxylates, e.g., RN(R′)R″, wherein R is a group containing from about 6 to 24 carbon atoms such as the residue of a fatty acid and R′ and R″ are each ethoxy or polyethoxy groups having an average of 1 to 6 ethoxy groups; block copolymers of ethylene oxide and propylene oxide, e.g., ethoxylated polyoxypropylene glycols and propoxylated polyoxyethylene glycols; acetylenic diols and ethoxylated acetylenic diols; fluorosurfactants, i.e., a fluorocarbon containing organic, e.g., alkoxy, or inorganic, e.g., sulfate, surface active and water solubilizing (polar) groups that orient the hydrophilic portion of the surfactant in the aqueous phase; and capped nonionics represented by the formula R(OCH₂CH₂)ₙR′ wherein R is C₆ to C₂₀ linear or branched alkyl, R′ is selected from halogen e.g., chloro, benzyl, phenoxy, C₁ to C₄ alkoxy or −0(CₘH₂ₘ0)pH wherein m is 3 or 4 and p is 1 to 5, and n denotes the average number of ethylene oxide units and is a whole or fractional number ranging from 3 to 20.

Advantageously, the nonionic surfactant is an ethoxylated alkyl phenol such as the IGEPAL® DM surfactants or octyl-phenoxypolyethoxyethanol (available as TRITON® X-100), an acetylenic diol such as 2,4,7,9-tetramethyl-5-decyne-4,7-diol (available as SURFYNOL® 104), ethoxylated acetylenic diols, such as the SURFYNOL®400 surfactant series, fluoro-surfactants, such as the FLUORAD® fluorochemical surfactant series, and capped nonionics such as the benzyl capped octyl phenol ethoxylates (available as TRITON® CF87), the propylene oxide capped alkyl ethoxylates, which are available as the PLURAFAC® RA series of surfactants, and octylphenoxyhexa-decylethoxy benzyl ether.

Still more particularly, the nonionic surfactant(s) may be selected from the group consisting of fluoroaliphatic polymeric esters, such as FLUORAD® FC-430, fluorinated alkyl polyoxyethylene ethanols, such as FLUORAD® FC-170-C, and fluorinated alkyl alkoxylates, such as as FLUORAD® FC-171. When using such fluorosurfactants in coating compositions containing fluorinated silanes, it may be necessary to use less fluorosurfactant than would be used in a coating composition without fluorinated silanes in order to obtain a durable coating.

A solvating amount of lower aliphatic alcohol solvent is present as a component in the coating composition. A solvating amount is that amount which is sufficient to solubilize the silane monomers in the coating composition. The solvating amount may represent up to about 40 weight percent of the coating composition. The lower aliphatic alcohol solvent as used herein and in the claims may be represented by the formula [(R³)ᵢR⁴]ⱼ(C₁-C₃)OH, wherein R³ and R⁴ are each C₁-C₂ alkoxy and i and j are each the integers 0 or 1. Preferably, the solvent is a C₁-C₃ alkanol or an aliphatic alcohol of the formula [(R³)ᵢR⁴]ⱼ(C₁-C₃)OH, wherein j is 1, and i is 0 or 1. Such solvents may be selected from the group consisting of methanol, ethanol, 2-ethoxyethanol, 2-(2-methoxyethoxy)ethanol, 2-methoxyethanol, 2-(2-ethoxymethoxy)ethanol, 1-propanol, 2-propanol, and 1-methoxy-2-propanol. Preferred solvents may be selected from the group consisting of methanol, ethanol, 1-propanol, and 1-methoxy-2-propanol. The most preferred solvent is methanol, ethanol or 1-propanol.

The coating composition also contains a catalytic amount of a water-soluble acid. A catalytic amount is that amount which is sufficient to result in the polycondensation of the silane monomers and their subsequent cross-linking with the water-soluble polymer. Typically, the catalytic amount of acid may range from 0.01 to 10.0 weight percent of the coating composition. The water-soluble acid may be an organic carboxylic acid or inorganic acid selected from the group consisting of acetic, formic, glutaric, maleic, nitric, hydrochloric, phosphoric, hydrofluoric, and sulfuric acid. Preferably, the acid is acetic acid. Water is also present in the coating composition in an amount sufficient to form hydrolysates of the silane monomers and to solubilize the water-soluble polymer component and the catalytic amount of water-soluble acid. The sum of all of the components of the coating composition totals 100 weight percent.

The coating compositions of the present invention may be prepared by adding a catalytic amount of acid to a solution of the water-soluble polymer. In a separate container, all of the silane monomers are mixed. The silane monomer mixture includes the first and second silane monomers with or without tetra(C₁-C₄) alkoxysilanes and may include fluorinated silanes. The silane monomer mixture is added to the water-soluble polymer/acid solution and stirred. To this mixture is added a solvating amount of lower aliphatic alcohol solvent and a leveling amount of nonionic surfactant. The resulting mixture is stirred and maintained either at about 60° C. for 1 to 2 hours or at room temperature for about 16 hours. Prior to use as a coating composition, the mixture is filtered through a suitable filter, such as a Whatman 934-AH filter. After forming the hydrolyzed coating composition, the pH is adjusted to from about 4 to 5 with a base. Suitable bases include ammonia, sodium hydroxide and tetra(C₁-C₄) alkyl ammonium hydroxide.

The process of producing a durable, cured antireflective coating on an organic polymeric host starts with coating at least one side of the organic polymeric host material with a composition of the present invention, or with a conventional durable coating composition known in the art. Typical conventional durable coating compositions contain hydrolyzed lower alkoxides and also may contain metal alkoxides. Suitable lower alkoxides include tetraethylorthosilicate, i.e., tetraethoxysilane, tetrabutylorthosilicate, tetraethylorthotitanate, tetrabutylorthotitanite, methyltriethoxysilane and methyltriethylorthotitanate. The alkoxides of metals such as germanium, aluminum, zirconium, boron and tin may also be employed in the durable coating composition. Such coating compositions when cured are optically clear, durable, i.e., resistant to abrasion and chemicals, and capable of forming a surface having a graded porosity.

The coating composition may be applied to the surface of the host material using a coating process such as that described in U.S. Pat. No. 3,971,872, the disclosure of which is incorporated herein by reference. Any suitable conventional coating method may be used. Conventional coating methods include flow coating, dip coating, spin coating, roll coating, curtain coating and spray coating. Application of the coating is typically done in an environment that is substantially free of dust.

It is well known in the art that preparation of the surface of the organic polymeric host material prior to coating is necessary for the purpose of cleaning the surface and promoting adhesion. Effective measures may include ultrasonic cleaning; washing with an aqueous mixture of solvent, e.g., a 50:50 mixture of isopropanol:water or ethanol:water; activated gas treatment, e.g., treatment with low temperature plasma or corona discharge, and chemical treatment such as hydroxylation, i.e., etching of the surface with an aqueous solution of alkali, e.g., sodium hydroxide or potassium hydroxide, or an aqueous alkaline solution, e.g., tetramethylammonium hydroxide, that may also contain a fluorosurfactant. See U.S. Pat. No. 3,971,872, column 3, lines 13 to 25; U.S. Pat. No. 4,904,525, column 6, lines 10 to 48; and U.S. Pat. No. 5,104,692, column 13, lines 10 to 59, which disclosures are incorporated herein by reference.

Following application of the coating composition to the surface of the host material, the coating is dried and cured. The coating may be dried at ambient temperatures or temperatures above ambient but below curing temperatures, e.g., up to about 80° C. Afterwards, the dried coated host is heated to a temperature of between about 80° C. and 130° C. for a period of about 1 to 16 hours in order to cure the coating. While a range of temperatures has been provided for drying and curing the coated organic polymeric host, it will be recognized by persons skilled in the art that temperatures other than those disclosed herein may be used. Additional methods for curing the coating include irradiating the coating with infrared, ultraviolet, gamma or electron radiation so as to promote the polymerization reaction of the polymerizable components in the coating.

The process of the present invention comprises treating the durable, cured coating with an aqueous acidic solution comprising from about 0.5 to 3.0 weight percent hydrofluoric acid and from about 0 to 1.0 weight percent nitric acid. The aqueous acidic solution may also contain and preferably contains a fluorosurfactant in an amount sufficient to provide uniform contact of the aqueous acidic solution with the surface of the coating i.e., a leveling amount. This treatment step is conducted for a time sufficient to produce a coating having a refractive index gradient within the coating. The time required for this treatment step may range from about 3 minutes to about 3 hours.

In the next step of the process, the treated coating, which has been first rinsed with water, is contacted with an aqueous alkaline leaching solution for a time sufficient to remove residual acid remaining on the coated surface. The time required for this treatment step ranges from about 3 minutes to about 1 hour. The aqueous alkaline leaching solution typically contains from about 0.05 to 0.15 weight percent of an alkaline reagent, which preferably is a tetra(C₁-C₄)alkyl ammonium hydroxide, e.g., tetramethyl-ammonium hydroxide, tetraethylammonium hydroxide, tetrapropylammonium hydroxide or tetrabutylammonium hydroxide. The aqueous leaching solution may also contain a fluorosurfactant, which preferably is the fluorinated alkylpolyoxyethylene ethanol, FLUORAD® FC 170-C, which material has the reported CAS No. 29117-08-6 and the molecular formula C₈F₁₇S0₂N(C₂H₅)(CH₂CH₂0)₁₄0.

The final step of the process is drying and further curing the coating after the aqueous alkaline leaching solution treated coating is rinsed with water. Drying and curing are done in the same manner as previously stated with respect to the durable coating composition. During this step, polycondensation of the Si-OH groups to Si-O-Si groups occurs in coatings containing such groups, thereby further improving the resistance of the coating to abrasion and chemicals. The use of the leaching step plus the final drying and curing step has produced durable, antireflective coatings that are more adherent and have less haze and greater visible light transmission than coatings produced using the same process without these two steps.

The surfaces of photochromic articles, i.e., articles containing photochromic amounts of organic photochromic compounds, are also suitable for application of a durable cured coating and the durable cured antireflective coating of the present invention. Photochromic compounds that may be utilized to prepare photochromic articles of the present invention, such as those heretofore described, are organic photochromic compounds having at least one activated absorption maxima within the range of between about 400 and 700 nanometers, or substances containing same that may be incorporated, e.g., dissolved or dispersed, in the organic polymeric host material used to prepare the photochromic articles.

Examples of organic photochromic compounds include naphthopyrans, benzopyrans, phenanthropyrans, spiro(benzindoline)naphthopyrans, spiro(indoline)benzopyrans, spiro(indoline)naphthopyrans, spiro(indoline)quinopyrans, spiro(indoline)pyrans, spiro(indoline)naphthoxazines, spiro(indoline)pyrido-benzoxazines, spiro(benzindoline)pyridobenzoxazines, spiro(benzindoline)naphthoxazines, spiro(indoline)-benzoxazines, and mixtures of such photochromic compounds.

Each of the photochromic substances described herein may be used in amounts (or in a ratio) such that an organic host material to which the photochromic compounds or mixture of compounds is applied or in which they are incorporated exhibits a desired resultant color, e.g., a substantially neutral color when activated with unfiltered sunlight, i.e., as near a neutral color as possible given the colors of the activated photochromic compounds.

A neutral gray color exhibits a spectrum that has relatively equal absorption in the visible range between 400 and 700 nanometers. A neutral brown color exhibits a spectrum in which the absorption in the 400-550 nanometer range is moderately larger than in the 550-700 nanometer range. An alternative way of describing color is in terms of its chromaticity coordinates, which describe the qualities of a color in addition to its luminance factor, i.e., its chromaticity. In the CIE system, the chromaticity coordinates are obtained by taking the ratios of the tristimulus values to their sum, e.g., x=X/(X+Y+Z) and y=Y/(x+Y+Z). Color as described in the CIE system can be plotted on a chromaticity diagram, usually a plot of the chromaticity coordinates x and y. See pages 47-52 of Principles of Color Technology, by F. W. Billmeyer, Jr., and Max Saltzman, Second Edition, John Wiley and Sons, N.Y. (1981). As used herein, a near neutral color is one in which the chromaticity coordinate values of “x” and “y” for the color are within the following ranges (D65 illuminant): x=0.260 to 0.400, y=0.280 to 0.400 following activation to 40 percent luminous transmission by exposure to solar radiation (Air Mass 1 or 2).

The amount of photochromic substance or composition containing same applied to or incorporated into a host material is not critical provided that a sufficient amount is used to produce a photochromic effect discernible to the naked eye upon activation. Generally such amount can be described as a photochromic amount. The particular amount used depends often upon the intensity of color desired upon irradiation thereof and upon the method used to incorporate or apply the photochromic substances. Typically, the more photochromic substance applied or incorporated, the greater is the color intensity up to a certain limit.

The relative amounts of the aforesaid photochromic compounds used will vary and depend in part upon the relative intensities of the color of the activated species of such compounds, and the ultimate color desired. Generally, the amount of total photochromic substance incorporated into or applied to a photochromic optical host material may range from about 0.05 to about 1.0, e.g., from 0.1 to about 0.45, milligrams per square centimeter of surface to which the photochromic substance(s) is incorporated or applied.

Photochromic substances may be applied to or incorporated into a host material such as a polymeric organic host material by various methods described in the art. Such methods include dissolving or dispersing the photochromic substance within the host material, e.g., casting it in place by adding the photochromic substance to the monomeric host material prior to polymerization; imbibition of the photochromic substance into the host material by immersion of the host material in a hot solution of the photochromic substance or by thermal transfer; providing the photochromic substance as a separate layer between adjacent layers of the host material, e.g., as a part of a polymeric film; and applying the photochromic substance as part of a coating placed on the surface of the host material. The term “imbibition” or “imbibe” is intended to mean and include permeation of the photochromic substance alone into the host material, solvent assisted transfer of the photochromic substance into a porous polymer, vapor phase transfer, and other such transfer mechanisms.

Compatible (chemically and color-wise) tints, i.e., dyes, may be applied to the host material to achieve a more aesthetic result, for medical reasons, or for reasons of fashion. The particular dye selected will vary and depend on the aforesaid need and result to be achieved. In one embodiment, the dye may be selected to complement the color resulting from the activated photochromic substances, e.g., to achieve a more neutral color or absorb a particular wavelength of incident light. In another embodiment, the dye may be selected to provide a desired hue to the host matrix when the photochromic substances is in an unactivated state.

The host material will usually be transparent, but may be translucent or even opaque. The host material need only be transparent to that portion of the electromagnetic spectrum, which activates the photochromic substance, i.e., that wavelength of ultraviolet (UV) light that produces the open form of the substance and that portion of the visible spectrum that includes the absorption maximum wavelength of the substance in its UV activated form, i.e., the open form. Preferably, the host color should not be such that it masks the color of the activated form of the photochromic substance, i.e., so the change in color is readily apparent to the observer. More preferably, the host material article is a solid transparent or optically clear material, e.g., materials suitable for optical applications, such as plano and ophthalmic lenses, windows, automotive transparencies, e.g., windshields, aircraft transparencies, plastic sheeting, polymeric films, etc.

Examples of polymeric organic host materials which may suitable for application of the durable cured coatings and the durable, antireflective cured coatings described herein include: polymers, i.e., homopolymers and copolymers, of polyol(allyl carbonate) monomers, diethylene glycol dimethacrylate monomers, diisopropenyl benzene monomers, ethoxylated bisphenol A dimethacrylate monomers, ethylene glycol bismethacrylate monomers, poly(ethylene glycol) bismethacrylate monomers, ethoxylated phenol methacrylate monomers and alkoxylated polyhydric alcohol acrylate monomers, such as ethoxylated trimethylol propane triacrylate monomers; polymers, i.e., homopolymers and copolymers, of polyfunctional, e.g., mono-, di- or multi-functional, acrylate and/or methacrylate monomers, poly(C₁-C₁₂ alkyl methacrylates), such as poly(methyl methacrylate), poly(oxyalkylene dimethacrylates), poly(alkoxylated phenol methacrylates), cellulose acetate, cellulose triacetate, cellulose acetate propionate, cellulose acetate butyrate, poly(vinyl acetate), poly(vinyl alcohol), poly(vinyl chloride), poly(vinylidene chloride), polyurethanes, thermoplastic polycarbonates, polyesters, poly(ethylene terephthalate), polystyrene, poly(alpha methylstyrene), copoly(styrene-methyl methacrylate), copoly(styrene-acrylonitrile), polyvinylbutyral and polymers, i.e., homopolymers and copolymers, of diallylidene pentaerythritol, particularly copolymers with polyol (allyl carbonate) monomers, e.g., diethylene glycol bis(allyl carbonate), and acrylate monomers.

Transparent copolymers and blends of transparent polymers are also suitable as host materials. Preferably, the host material is an optically clear polymerized organic material prepared from a thermoplastic polycarbonate resin, such as the carbonate-linked resin derived from bisphenol A and phosgene, which is sold under the trademark, LEXAN; a polyester, such as the material sold under the trademark, MYLAR; a poly(methyl methacrylate), such as the material sold under the trademark, PLEXIGLAS; polymerizates of a polyol(allyl carbonate) monomer, especially diethylene glycol bis(allyl carbonate), which monomer is sold under the trademark CR-39, and polymerizates of copolymers of a polyol (allyl carbonate), e.g., diethylene glycol bis(allyl carbonate), with other copolymerizable monomeric materials, such as copolymers with vinyl acetate, e.g., copolymers of from 80-90 percent diethylene glycol bis(allyl carbonate) and 10-20 percent vinyl acetate, particularly 80-85 percent of the bis(allyl carbonate) and 15-20 percent vinyl acetate, and copolymers with a polyurethane having terminal diacrylate functionality, as described in U.S. Pat. Nos. 4,360,653 and 4,994,208; and copolymers with aliphatic urethanes, the terminal portion of which contain allyl or acrylyl functional groups, as described in U.S. Pat. No. 5,200,483; poly(vinyl acetate), polyvinylbutyral, polyurethane, polymers of members of the group consisting of diethylene glycol dimethacrylate monomers, diisopropenyl benzene monomers, ethoxylated bisphenol A dimethacrylate monomers, ethylene glycol bismethacrylate monomers, poly(ethylene glycol) bismethacrylate monomers, ethoxylated phenol methacrylate monomers and ethoxylated trimethylol propane triacrylate monomers; cellulose acetate, cellulose propionate, cellulose butyrate, cellulose acetate butyrate, polystyrene and copolymers of styrene with methyl methacrylate, vinyl acetate and acrylonitrile.

More particularly, contemplated is use of the organic photochromic compounds with optical organic resin monomers used to produce optically clear polymerizates, i.e., materials suitable for optical applications, such as for example plano and ophthalmic lenses, windows, and automotive transparencies. Such optically clear polymerizates may have a refractive index that may range from about 1.48 to about 1.75, e.g., from about 1.495 to about 1.66. Specifically contemplated are optical resins sold by PPG Industries, Inc. under the designation CR-307 and CR-407.

The organic polymeric host materials suitable for application of the durable cured coatings and the durable, antireflective cured coatings described herein may be in the form of optical elements such as windows, plano and vision correcting ophthalmic lenses, exterior viewing surfaces of liquid crystal displays, cathode ray tubes e.g., video display tubes for televisions and computers, clear polymeric films, automotive transparencies, e.g., windshields, aircraft transparencies, plastic sheeting, etc. Application of the antireflective coating to a polymeric film referred to as an “applique”may be accomplished using the methods described in column 17 line 28 to column 18 line 57 of U.S. Pat. No. 5,198,267, which disclosure is herein incorporated by reference.

The present invention is more particularly described in the following examples, which are intended as illustrative only, since numerous modifications and variations therein will be apparent to those skilled in the art.

### Example 1

### Step 1

Polyvinyl alcohol (PVA), 87 to 89 percent hydrolyzed (40 grams), having a number average molecular weight of approximately 150,000 was added to a reaction flask containing 760 grams of distilled water maintained at 95° C. The mixture was stirred until the PVA was completely dissolved yielding a 5 weight percent PVA solution.

### Step 2

180 grams of the 5 weight percent PVA solution from Step 1 was added to a reaction flask containing glacial acetic acid (24 grams) and stirred. A mixture of 180 grams of methyltrimethoxysilane (a second silane monomer) and 18 grams of gamma-glycidoxypropyltrimethoxysilane (a first silane monomer) was added to the flask. After stirring five minutes, 30 grams of HPLC grade methanol having an assay greater than or equal to 99.9 percent was added and the mixture was stirred for 18 hours at room temperature. FLUORAD® FC-430 fluoroaliphatic polymeric ester nonionic surfactant (1.12 grams) was added to the flask and the solution was stirred 30 minutes The solution was filtered through a Whatman 934-AH filter prior to use as a coating composition.

### Example 2

200 grams of the final product of Example 1 was diluted with a mixture of 100 grams of ethanol (assay of about 95 weight percent) and water (100 grams). The resulting solution was stirred and filtered prior to use as a coating composition.

### Example 3

Twenty-four grams of glacial acetic acid was added to a reaction flask containing 180 grams of the 5 weight percent PVA solution from Step 1 of Example 1, and stirred. A mixture of methyltrimethoxysilane (162 grams), gamma-glycidoxypropyl-trimethoxysilane (40 grams), and 3,3,3-trifluoropropyltrimethoxysilane (16 grams) was added. After stirring for 5 minutes, 40 grams of methanol was added and the mixture was stirred for 90 minutes while being maintained at 60° C. The solution was cooled to room temperature; 1.12 grams of FLUORAD® FC-430 fluoroaliphatic polymeric ester surfactant was added to the solution; and the solution was stirred for 30 minutes. The solution was filtered prior to use as a coating composition.

### Example 4

To a reaction flask was added 180 grams of methyltrimethoxysilane, 18 grams of gamma-glycidoxy-propyltrimethoxysilane, 10 grams of tetraethylorthosilicate, 200 grams of the 5 weight percent PVA solution from Step 1 of Example 1, 30 grams of glacial acetic acid and 36 grams of methanol. The solution was stirred for one hour while being maintained at 60° C. FLUORAD® FC-430 fluoroaliphatic polymeric ester surfactant (1.2 grams) was added to the reaction mixture which was then cooled to ambient temperature and stirred for 16 hours. The solution was filtered prior to use as a coating composition.

### Example 5

### Step 1

Hydroxyethyl cellulose (20 grams) having a number average molecular weight within the range of 50,000 to 100,000 (CAS No. 9004-62-0; available from Aldrich Chemical Products), was added to a reaction flask containing 980 grams of distilled water maintained at 95° C. The mixture was stirred until completely dissolved yielding a 2 weight percent hydroxyethyl cellulose solution.

### Step 2

To a reaction flask was added 90 grams of the product prepared in Step 1, 14 grams of glacial acetic acid, 90 grams of methyltrimethoxysilane, 9 grams of gamma-glycidoxy-propyltrimethoxysilane, and 15 grams of methanol. The contents of the reaction flask were heated to and maintained at 60° C. and stirred for one and one-half hours, then cooled to room temperature and stirred for 16 hours. The solution was filtered prior to use as a coating composition.

### Examples 6-28

The procedure of Example 1 was followed in the preparation of the coating compositions of Examples 6-28 using the quantity in grams of the specific ingredients listed in Tables 1, 2 and 3.

TABLE 1

| No. | Ex 6 | Ex 7 | Ex 8 | Ex 9 | Ex 10 | Ex 11 | Ex 12 | Ex 13 | Ex 14 | Ex 15 |
|---|---|---|---|---|---|---|---|---|---|---|
| WT Ratio(*) | 0:1 | 1:20 | 1:2 | 1:3 | 1:0 | 0:1 | 1:20 | 1:2 | 1:3 | 1:0 |
| 5% PVA^{(a)} | 100 | 100 | 100 | 100 | 100 | 100 | 100 | 100 | 100 | 100 |
| glacial | 12 | 12 | 12 | 12 | 12 | 12 | 12 | 12 | 12 | 12 |
| Acetic acid | | | | | | | | | | |
| A-163^{(b)} | 98.5 | 90 | 70 | 80 | 0 | 98.5 | 90 | 70 | 80 | 0 |
| A-187^{(c)} | 0 | 4.5 | 35 | 26.6 | 108.5 | 0 | 4.5 | 35 | 26.8 | 98.5 |
| TEOS^{(d)} | 0 | 0 | 0 | 0 | 0 | 14 | 10 | 10 | 10 | 10 |
| HPLC grade | 15 | 15 | 15 | 15 | 15 | 15 | 15 | 15 | 15 | 15 |
| Methanol | | | | | | | | | | |
| FC-430^{(e)} | 0.5 | 0.5 | 0.5 | 0.5 | 0.5 | 0.5 | 0.5 | 0.5 | 0.5 | 0.5 |

(*)The weight ratio of the first silane monomer to the second silane monomer.
^{(a)}5 weight percent PVA solution described in Example 1.
^{(b)}Methyltrimethoxysilane (a second silane monomer, as previously defined)
^{(c)}gamma-Glycidoxypropyltrimethoxys (a first silane monomer, as previously defined)
^{(d)}Tetraethylorthosilicate
^{(e)}FLUORAD ® FC-430 described as a fluoro aliphatic polymeric ester nonionic surfactant.

TABLE 2

| No. | Ex 16 | Ex 17 | Ex 18 | Ex 19 | Ex 20 | Ex 21 | Ex 22 | Ex 23 |
|---|---|---|---|---|---|---|---|---|
| WT Ratio⁽*⁾ | 1:4 | 1:4 | 1:4 | 1:7 | 1:7 | 1:15 | 1:15 | 1:20 |
| 5% PVA^{(a)} | 100 | 100 | 100 | 100 | 100 | 100 | 100 | 100 |
| glacial | 12 | 12 | 12 | 12 | 12 | 12 | 12 | 12 |
| Acetic acid | | | | | | | | |
| A-163^{(b)} | 80 | 80 | 80 | 87.5 | 87.5 | 93.75 | 93.75 | 95.2 |
| A-187^{(c)} | 20 | 20 | 20 | 12.5 | 12.5 | 6.25 | 6.25 | 4.8 |
| TriFl^{(d)} | 0 | 0 | 5 | 0 | 0 | 0 | 0 | 5 |
| TEOS^{(e)} | 10 | 0 | 0 | 0 | 0 | 10 | 0 | 0 |
| HPLC grade | 15 | 15 | 15 | 15 | 15 | 15 | 15 | 15 |
| Methanol | | | | | | | | |
| FC-430^{(f)} | 2.2 | 2.2 | 2.2 | 2.2 | 2.2 | 2.2 | 2.2 | 2.2 |

⁽*⁾The weight ratio of the first silane monomer to the second silane monomer.
^{(a)}5 weight percent PVA solution described in Example 1.
^{(b)}Methyltrimethoxysilane (a second silane monomer, as previously defined)
^{(c)}gamma-Glycidoxypropyltrimethoxysilane (a first silane monomer, as previously defined)
^{(d)}3,3,3-Trifluoropropyltrimethoxysilane
^{(e)}Tetraethylorthosilicate
^{(f)}FLUORAD ® FC-430 which is described as a fluoro aliphatic polymeric ester nonionic surfactant.

TABLE 3

| No. | Ex 24 | Ex 25 | Ex 26 | Ex 27 | Ex 28 |
|---|---|---|---|---|---|
| WT Ratio⁽*⁾ | 1:4 | 1:4 | 1:4 | 1:15 | 1:20 |
| 5% PVA^{(a)} | 100 | 100 | 100 | 100 | 100 |
| glacial | 12 | 12 | 12 | 12 | 12 |
| Acetic acid | | | | | |
| A-163^{(b)} | 80 | 80 | 80 | 93.75 | 96 |
| A-187^{(c)} | 20 | 20 | 20 | 6.25 | 4.8 |
| TriFl^{(d)} | 0 | 0 | 5 | 0 | 5 |
| TEOS^{(e)} | 10 | 0 | 0 | 0 | 0 |
| HPLC grade | 15 | 15 | 15 | 15 | 15 |
| Methanol | | | | | |
| FC-430^{(f)} | 0.5 | 0.5 | 0.5 | 0.5 | 0.5 |

⁽*⁾The weight ratio of the first silane monomer to the second silane monomer.
^{(a)}5 weight percent PVA solution described in Example 1.
^{(b)}Methyltrimethoxysilane (a second silane monomer, as previously defined)
^{(c)}gamma-Glycidoxypropyltrimethoxysilane (a first silane monomer, as previously defined)
^{(d)}3,3,3-Trifluoropropyltrimethoxysilane
^{(e)}Tetraethylorthosilicate
^{(f)}FLUORAD ® FC-430 which is described as a fluoro aliphatic polymeric ester nonionic surfactant.

### Comparative Example

The coating composition for forming fluorine-containing organopolysiloxane films described in Example 1 of U.S. Pat. No. 4,904,525 was duplicated as follows: methyltrimethoxysilane (9.8 grams) and 3,3,3-trifluoropropyltrimethoxysilane (7.0 grams) were added to a reaction flask and stirred. The reaction mixture was cooled to 10° C. and 5.6 grams of 0.01 N aqueous hydrochloric acid was added dropwise while stirring. After adding the hydrochloric acid, the reaction flask was warmed to room temperature. The following chemicals were added subsequently to the reaction flask and stirred to produce the final product: Fisher Certified n-propanol (112 grams); distilled water (48 grams); ethyl CELLOSOLVE® (ethylene glycol diethyl ether, 15 grams); 2 grams of a 5 weight percent silicone-based, nonionic surface active agent in n-propanol (available as SILWET® L-564); and aluminum acetylacetonate (0.48 grams).

### Example 29

### Part A

Test samples of square polymerizates and plano lenses prepared from CR-39® diethylene glycol bis(allyl carbonate) monomer were cleaned ultrasonically for ten minutes and those samples to be coated with the example coating compositions except Example 1 were etched in a 15 weight percent aqueous sodium hydroxide solution for 12 to 20 minutes at room temperature. The square polymerizates measured ⅛ inch (0.3 centimeters) x2 inches (5.1 centimeters) x2 inches (5.1 centimeters). The test samples to be coated with the coating composition of Example 1 were etched in a 15 weight percent aqueous sodium hydroxide solution that contained 0.05 weight percent FLUORAD® FC-170-C fluorinated alkylpolyoxyethylene ethanol Afterwards, the test samples were rinsed first with water and then rinsed with a 50:50 mixture of ethanol:water or isopropanol:water and air dried. The coating compositions of Examples 1 through 4 were applied on the test samples by dip coating. The withdraw rate used was approximately 8 to 10 centimeters per minute for the coating composition of Example 1 and approximately 15 centimeters per minute for Examples 2, 3 and 4. Afterwards, the coated test samples (except the test sample coated with Example 2, which was dried at 60° C. for 30 minutes) were dried at room temperature for 30 minutes and then cured in an air-circulating oven at the temperatures and time intervals listed in Table 1.

The test samples coated with the compositions of Example 2 through 4 were treated with an aqueous 1.5 weight percent hydrofluoric acid solution for 35 minutes. The test sample coated with the coating composition of Example 1 was treated with a 1.5 weight percent hydrofluoric acid solution that contained 0.06 weight percent FLUORAD® FC-170-C fluorinated alkylpolyoxyethylene ethanol. After this treatment, the coated test samples were rinsed with water and all of the samples, except the sample coated with the coating composition of Example 1, were treated with an aqueous leaching solution of 0.1 weight percent tetramethylammonium hydroxide. The test sample coated with the coating composition of Example 1 was treated with an aqueous leaching solution that also contained 0.05 weight percent FLUORAD® FC-170-C fluorinated alkylpolyoxyethylene ethanol. All of the test samples were subsequently rinsed with water and dried in an air stream. The treated test samples coated with the coating composition of Examples 2 through 4 were cured in an oven maintained at 95° C. for one hour and the sample coated with the coating composition of Example 1 was cured at 95° C. for two hours.

Test samples coated with the coating composition of Example 5 were prepared and processed in the same manner as the test samples coated with the coating composition of Examples 2 through 4 above except that they were etched in 20 weight percent aqueous sodium hydroxide maintained at 60° C. for 40 minutes and treated with 1.0 weight percent hydrofluoric acid for one hour at room temperature. The test squares coated with the coating composition of Example 5 were examined visually. The resulting coatings demonstrated an antireflective effect on comparison with an uncoated test square.

### Part B

Abrasion resistance of the coated and treated test samples prepared in Part A was determined using ASTM Test Method F735-81. The test samples were exposed to 600 cycles of oscillation in the ASTM Test Method. The Bayer Abrasion Resistance Index (BARI), listed in Table 4, was calculated by dividing the difference in the percent haze before and after the ASTM Test Method of an uncoated test sample made of a homopolymer prepared from CR-39® monomer by the difference in the percent haze of the coated test sample. The resulting number is an indication of how much more abrasion resistant the coated test sample is as compared to the uncoated test square. The haze and transmission results before and after abrasion testing were measured with a Hunter Lab Model DP25P Colorimeter.

Adhesion of the antireflective coating on the test lenses was measured using the cross-hatch peel test. A criss-cross pattern (grid) was scribed on the coating surface, 3M Scotch Tape #600 was pressed firmly against the grid area and then removed in one quick motion. The results of this test were measured as either pass or fail. Samples that passed the cross-hatched peel test were immersed and held in boiling water for one hour to “age” the coated sample. After cooling to room temperature, the grid area was retested with the cross-hatch peel. Results reported in Table 4 are for samples that have undergone “aged” adhesion testing. The thickness of the coating on the test lenses was determined by transmission electron microscopy (TEM) analysis of a cross-sectional section of the coated test samples that had a thickness of approximately 1000 Angstroms. The results are listed in Table 4.

### Part C

Transitions® Plus lens blanks, a photochromic plastic lens blank reported to be prepared from a polymerizate of a polyol (allyl carbonate) composition, which are sold by Transitions Optical Company, were coated with the coating composition of Example 1. The lens blanks were cleaned and processed according to the procedure of Part A used to prepare test samples coated with the coating composition of Example 1.

A second set of Transitions® Plus lens blanks were coated by Reflection Free, a division of Essilor of America, with the commercially available antireflective (AR) coating sold as Reflection Free® Plus. This coating is a vacuum deposited AR coating.

According to the American National Standards Institute (ANSI) Z80.1-1987, an ophthalmic lens should not be damaged when subjected to a minimum impact force of 0.15 foot pounds (0.2 Joule). This force results when a ⅝ inch (1.6 cm.) diameter steel ball is dropped 50 inches (127 cm.) onto a lens. Impact testing on Transitions® Plus lens blanks coated with the coating composition from Example 1 and processed as described in Part A of this Example, and Transitions® Plus lens blanks coated with the Reflection Free® Plus coating was performed on an instrument similar to the American Optical instrument described in U.S. Pat. No. 3,896,657. This instrument is considered a gravity accelerator and enables quantification of the force in foot pounds necessary to damage the lens. Results in foot pounds necessary to cause any damage to the coated lenses are listed in Table 5.

The percent loss of photochromic performance at 480 and 620 nanometer wavelengths for uncoated Transitions® Plus lens blanks, blanks coated with the coating composition of Example 1, and blanks coated with Reflection Free® Plus coating described above was determined using an optical bench. The bench was mounted with a 300 watt Xenon arc lamp operated at about 200 watts, a remote controled shutter, a Schott W G 320 nm cut-off filter which removes short wave length radiation; neutral density filter(s) and a constant temperature water bath in which the sample to be tested was immersed. Before testing on the optical bench, the lenses were exposed to 365 nanometer ultraviolet light for 15 minutes to activate the photochromic compounds and then placed into an oven maintained at 76° C. for 15 minutes to inactivate or bleach the photochromic compounds. The lenses were cooled to room temperature, exposed to fluorescent room light for at least 2 hours and then kept in the dark for at least 2 hours. Afterwards, the lenses were placed in a water bath maintained at 22.2° C. on the optical bench and illuminated for 10 minutes. During this time period, a collimated beam of light from a tungsten lamp was passed through the sample at a small angle to the normal of the sample. After the light from the tungsten lamp passed through the test sample, it was directed to a 50/50 beam splitter that sent half of the light to separate silicon photo detectors that measured 480 nm and 620 nm light, respectively. The output signals from the detectors were processed by a radiometer which delivered data to a computer. The change in optical density (ΔOD) over the 10-minute interval was measured for the coated and uncoated photochromic lens blanks The difference in optical density between the coated and the uncoated photochromic lens blanks was divided by the optical density for the uncoated sample and multiplied by 100 to give the percent loss of photochromic performance listed in Table 5.

Resistance to chemical attack was determined for test lenses coated with the composition of Example 1 and treated as described in Part A of this Example. Testing was done by soaking test lenses separately in ethanol, isopropanol and acetone for 30 minutes at room temperature, and in water maintained at 95° C. for two hours. If the coating on the lens showed no evidence of peeling, flaking or blistering after removal from each of the test liquids, the lens was considered to have passed the test. The result is listed in Table 5.

Plano lenses made of a homopolymer prepared from CR-39® monomer were coated with the coating composition of Example 1 and processed in accordance with the procedure of Part A of this Example that was used to prepare the test samples coated with the coating compositions of Examples 2 through 4. Several variables in the processing of the lenses were evaluated for their effects on percent transmission and percent haze. These variables were: concentration of hydrofluoric acid, the time period of acid treatment, and treatment with the aqueous leaching solution. The results are listed in Table 6.

Another set of plano lenses were coated with the coating composition of Example 1 and processed according to the procedure of Part A used to prepare test squares coated with the coating composition of Example 1. Process variables tested for their effects on coating adhesion were:(a) the presence 0.05 weight percent fluorinated alkylpolyoxyethylene ethanol nonionic surfactant in the aqueous 1.5 weight percent hydrofluoric acid solution and in the aqueous 0.1 weight percent tetramethylammonium hydroxide leaching solution and (b) use of a final curing step of heating at 95° C. for one hour. Adhesion testing was done as described in Part B hereof except that the samples were not aged. Results are listed in Table 6 wherein a (+) indicates use of the process variable and a (−) indicates the absence of the process variable.

### PART D

The procedure of Part A was used to prepare test samples of square polymerizates that were coated with the compositions of Examples 6-28 except for the following modifications to the procedure: the withdraw rate used was approximately 14 centimeters per minute; the coated test samples were cured in an air-circulating oven at 115° C. for 3 hours; the test polymerizates having the cured coating were treated with an aqueous solution of 0.75 weight percent hydrofluoric acid, 0.15 weight percent nitric acid, and 0.05 weight percent FLUORAD® FC-170-C fluorinated alkylpolyoxyethylene ethanol for the time intervals listed in Tables 8, 9 and 10; and the percent reflectance of the treated samples was measured with a SHIMADZU UV/Vis Scanning Spectrophotometer Model No. 2101 PC. The percent reflectance results and a (+) indication if the coating PASSED, i.e., the percent reflectance of the coating was less than about 5.0, are listed in the Tables 8, 9 and 10.

TABLE 4

| | | | | | COMPARA- |
|---|---|---|---|---|---|
| | | | | | TIVE |
| Test | EX 1 | EX 2 | EX 3 | EX 4 | EXAMPLE |
| Optical Trans- | 99.0 | 98.0 | 98.1 | 98.4 | 95.8% |
| mission, Percent | | | | | |
| BARI | 1.5 | 1.5 | 0.8 | 1.2 | 1.15 |
| Haze, % | 0.3 | 0.2 | 0.1 | 0.5 | 0.33 |
| Adhesion | Passed | Passed | Passed | Passed | Passed |
| Thickness, μm | 7 | 3.2 | 6 | 6.5 | 0.15 |
| Hardcoat | 120 | 120 | 92 | 120 | 93 |
| Cure Temp. ° C. | | | | | |
| Hardcoat Cure | 4 | 5 | 16 | 3 | 4 |
| Time, (hrs) | | | | | |

The results of Table 4 show improved optical transmission for the test samples prepared using the compositions of Examples 1 through 4, and reduced percent haze for the samples prepared using the compositions of Examples 2 and 3 as compared to the results for the test sample prepared using the composition of the Comparative Example. The BARI results for test samples prepared using the compositions of Examples 1, 2 and 4 are better than the uncoated test square.

TABLE 5

| | Example 1 | Reflection |
|---|---|---|
| Test | Coating | Free ® Plus |
| Optical Transmission, percent | 88.2 | 88.8 |
| Impact, foot pound | 0.6 | 0.3 |
| Percent Loss of Photochromic | | |
| Performance at: | | |
| a) 480 nm | 3.6 | 22 |
| b) 620 nm | 2.5 | 25 |
| Chemical Resistance | Passed | ND* |

*Not Determined

The results of Table 5 show that Transitions® Plus photochromic lenses coated with the coating composition of Example 1 and treated to become antireflective have a comparable percent optical transmission, a greater resistance to impact and a lower percent loss of photochromic performance compared to Transitions® Plus lenses coated with the Reflection Free® Plus antireflective coating. The lenses coated with the composition of Example 1 and treated to become antireflective pass the chemical resistance test.

TABLE 6

| | Treatment | | | |
|---|---|---|---|---|
| Wt. % | Time | Leaching | Percent | Percent |
| HF | in Minutes | Step* | Transmission | Haze |
| 1.5 | 35 | − | 96.8 | 0.72 |
| 1.5 | 35 | + | 99.3 | 0.43 |
| 1.5 | 40 | − | 96.5 | 0.91 |
| 1.5 | 40 | + | 99.0 | 0.46 |
| 1.5 | 45 | − | 96.5 | 1.03 |
| 1.5 | 45 | + | 98.7 | 0.72 |
| 2.5 | 15 | − | 96.0 | 0.40 |
| 2.5 | 15 | + | 97.7 | 0.23 |
| 2.5 | 20 | − | 95.1 | 0.61 |
| 2.5 | 20 | + | 98.6 | 0.35 |
| 2.5 | 25 | − | 97.3 | 0.79 |
| 2.5 | 25 | + | 98.3 | 0.45 |

(−) Leaching Step not used
(+) Leaching Step used

The results of Table 6 show the positive effect of the leaching step, i.e., contact with the aqueous leaching solution containing 0.1 weight percent of tetramethylammonium hydroxide, on the percent transmission and percent haze of the antireflective coating prepared with the coating composition of Example 1. In each comparison, the lenses processed with the leaching step have a higher percent transmission and a lower percent haze than lenses processed without the leaching step.

TABLE 7

Presence/Absence of
Fluorosurfactant in

| Aqueous Acidic | Leaching | Final | |
|---|---|---|---|
| Solutions | Solution | Curing | Adhesion |
| − | − | − | Failed |
| − | − | + | Failed |
| + | + | − | Failed |
| + | + | + | Passed |

The results of Table 7 show the effect of the presence of 0.05 weight percent fluorinated alkylpolyoxyethylene ethanol surfactant in the aqueous acidic solution and in the aqueous leaching solution, and the inclusion of a final curing step on the adhesion of the coating prepared from the coating composition of Example 1. The lens processed with fluorosurfactant present in the aqueous acidic solutions and in the aqueous leaching solution and cured at 95° C. for one hour passed the adhesion test.

TABLE 8

| Time | | | | | | | | | | |
|---|---|---|---|---|---|---|---|---|---|---|
| (sec) | Ex 6 | Ex 7 | Ex 8 | Ex 9 | Ex 10 | Ex 11 | Ex 12 | Ex 13 | Ex 14 | Ex 15 |
| 0 | 5.71 | 5.78 | 6.27 | 6.19 | 6.82 | 6.00 | 5.88 | 6.40 | 6.22 | 6.82 |
| 10 | 5.73 | 5.78 | 6.27 | 6.20 | 6.82 | 5.99 | 5.88 | 6.39 | 6.21 | 6.84 |
| 30 | 5.74 | 5.81 | 6.26 | 6.20 | 6.83 | 5.99 | 5.88 | 6.40 | 6.22 | 6.79 |
| 50 | 5.73 | 5.81 | 6.30 | 6.22 | 6.82 | 5.99 | 5.87 | 6.40 | 6.22 | 6.78 |
| 70 | 5.73 | 5.83 | 6.25 | 6.20 | 6.83 | — | — | — | — | — |
| 80 | —* | — | — | — | — | 6.01 | 5.30 | peeled off | 5.85 | 6.74 |
| 90 | 5.72 | 5.83 | 6.25 | 6.18 | 6.83 | — | 4.80 | — | — | — |
| 100 | — | — | — | — | — | 6.01 | 4.05 | — | 5.11 | 6.70 |
| 110 | 5.69 | 5.85 | 6.23 | 6.19 | 6.80 | — | 3.47 | — | — | |
| | peeled off | | | | | | | | | |
| 120 | — | — | — | — | — | — | 3.34 | — | 4.35 | — |
| 130 | — | — | — | — | — | — | 2.79 | — | — | — |
| 140 | — | — | — | — | — | — | 2.64 | — | cracked | — |
| 180 | — | — | — | — | — | — | 1.95 | — | — | — |
| PASSED | − | − | − | − | − | − | + | − | + | − |

—* Indicates that a reading wasn't taken.

TABLE 9

| Time | | | | | | | | |
|---|---|---|---|---|---|---|---|---|
| (sec) | Ex 16 | Ex 17 | Ex 18 | Ex 19 | Ex 20 | Ex 21 | Ex 22 | Ex 23 |
| 0 | 6.25 | 6.13 | 5.90 | 6.07 | 6.10 | 6.14 | 6.02 | 5.75 |
| 10 | 6.22 | 6.16 | 5.96 | 6.09 | 6.10 | 6.15 | 6.03 | 5.75 |
| 20 | 6.22 | 6.14 | 6.01 | 6.09 | 6.09 | 6.13 | 6.01 | 5.72 |
| 30 | 6.22 | 6.15 | 6.01 | 6.09 | 5.92 | 5.90 | 6.02 | 5.72 |
| 40 | 6.19 | 6.15 | 6.01 | 6.01 | 5.11 | 5.67 | 6.00 | 5.74 |
| 50 | 6.16 | 6.15 | 6.00 | 5.82 | 4.78 | 5.26 | — | 5.76 |
| 70 | peeled off | 6.15 | 5.96 | 4.73 | 4.31 | 4.94 | 5.99 | 5.75 |
| 90 | —* | 6.14 | 5.92 | 3.27 | 2.77 | 3.88 | 5.97 | 5.74 |
| 100 | — | 6.10 | peeled off | 3.10 | 2.51 | 3.27 | 5.92 | — |
| 120 | — | — | — | peeled off | 2.33 | 2.90 | 5.85 | — |
| 140 | — | — | — | — | 2.17 | peeled off | peeled off | — |
| 160 | — | — | — | — | peeled off | — | — | — |
| PASSED | − | − | − | + | + | + | − | − |

—* Indicates that a reading wasn't taken.

TABLE 10

| Time | | | | | |
|---|---|---|---|---|---|
| (sec) | Ex 24 | Ex 25 | Ex 26 | Ex 27 | Ex 28 |
| 0 | 6.27 | 6.17 | 5.93 | 6.07 | 6.14 |
| 10 | 6.27 | 6.15 | 5.92 | 6.07 | 6.14 |
| 20 | 6.25 | 6.07 | 5.93 | 6.07 | 6.15 |
| 30 | 6.24 | 6.07 | 5.93 | 6.09 | 6.14 |
| 40 | 6.20 | 6.12 | 5.92 | 6.02 | 6.14 |
| 60 | 5.91 | 6.02 | 5.69 | 5.94 | 6.13 |
| 80 | 5.76 | 5.94 | 5.23 | 5.83 | 6.11 |
| 100 | 5.11 | 5.88 | 4.97 | 5.72 | 6.09 |
| 120 | 4.93 | 5.74 | 4.63 | 5.43 | 6.03 |
| 140 | peeled off | 5.56 | peeled off | 5.01 | peeled off |
| 160 | —* | 5.50 | — | peeled off | — |
| | | peeled off | | | |
| PASSED | + | − | + | + | − |

—*Indicates that a reading wasn't taken.

The results of Tables 8, 9 and 10 show that antireflective coatings having an optical transmission greater than about 95%, i.e., a percent reflectance of less than about 5, were prepared with the coating compositions of Examples 12, 14, 19, 20, 21, 24, 26 and 27. The final condition of the coating, e.g., peeled off or cracked, was not considered to be critical in determining if the coating PASSED since the treatment step could be repeated and stopped at a time interval after reaching a percent reflectance level of less than about 5 and before the cracking or peeling of the coating. The percent reflectance obtained with the coating compositions of Examples 12, 14, 19, 20, 21, 24, 26 and 27 may be further reduced by the inclusion of a leaching step which was not done to the coatings prepared from Examples 6-28.

While the present invention has been described with reference to specific details of certain embodiments thereof, it is not intended that such details should be regarded as limitations upon the scope of the invention except insofar as they are included in the accompanying claims.

We claim:

1. A coating composition consisting essentially of:
(a) from about 20 to about 70 weight percent of a silane monomer mixture of (i) a first silane monomer which is a glycidoxy(C₁-C₃)alkyl(C₁-C₂)ₐ alkyl(C₁-C₂)_{b} alkoxysilane wherein a is an integer of from 0 to 2 and b is the integer 2 or 3, provided that b is 3 only when a is 0 or 1, and (ii) a second silane monomer having the general formula (x)_{c}(C₁-C₃)_{d}alkyl(C₁-C₃)ₑalkyl(R¹)_{f}Si_{4-(d+e+f)}, wherein X is selected from the group consisting of mercapto, amino, chloro and methacryloxy, R¹ is C₁-C₄ alkoxy or acetoxy, and c and d are each the integers 0 or 1, e is the integer 1 or 2, and f is the integer 2 or 3, the weight ratio of (i):(ii) being from about 1:3 to about 1:20;
(b) from about 1 to about 40 weight percent of tetra(C₁-C₄)alkoxysilane;
(c) a binding amount of silane monomer-compatible water-soluble organic polymer;
(d) a leveling amount of nonionic surfactant;
(e) a solvating amount of lower aliphatic alcohol;
(f) a catalytic amount of water-soluble acid; and
(g) water in an amount sufficient to form hydrolysates of said silane monomers and to solubilize said water-soluble polymer and acid.

2. The coating composition of claim 1 wherein the amount of the silane monomer mixture is from about 20 to about 55 weight percent, the weight ratio of (i):(ii) is from about 1:4 to about 1:15; the amount of tetra(C₁-C₄)alkoxysilane is from about 2 to about 20 weight percent; the water-soluble polymer is selected from the group consisting of hydroxyethyl cellulose, polyvinyl alcohol, and polyvinyl pyrrolidone and is present in an amount of from about 1 to about 8 weight percent; said nonionic surfactant is selected from the group consisting of alkyl phenol ethoxylates, fluoroaliphatic polymeric esters and fluorinated alkyl polyoxyethylene ethanols; and the lower aliphatic alcohol is C₁-C₃ alkanol or aliphatic alcohol of the formula [(R³)ᵢR⁴]ⱼ(C₁-C₃)OH, wherein R³ and R⁴ are each C₁-C₂ alkoxy, i is the integer 0 or 1, and j is the integer 1.

3. The coating composition of claim 2 wherein the amount of the silane monomer mixture is from about 20 to about 45 weight percent, the weight ratio of (i):(ii) is from about 1:7 to about 1:10; the amount of the tetra(C₁-C₄)alkoxysilane is from about 2 to 10 weight percent; the lower aliphatic alcohol is selected from the group consisting of methanol, ethanol, 1-propanol and 1-methoxy-2-propanol; and the water-soluble acid is acetic acid or nitric acid.

4. The composition of claim 1 wherein the first silane monomer is gamma-glycidoxypropyltrimethoxysilane, gamma-glycidoxypropylmethyldimethoxysilane, gamma-glycidoxy-propyldimethylethoxysilane, hydrolysates thereof, or mixtures of such silane monomers; the second silane monomer is methyltrimethoxysilane, methyltriethoxysilane, ethyltri-methoxysilane, ethyltriethoxysilane, hydrolysates thereof or mixtures of such silane monomers; the water-soluble polymer is a polyvinyl alcohol that is at least 72 percent hydrolyzed; the nonionic surfactant is a fluoroaliphatic polymeric ester; the lower aliphatic alcohol is methanol, ethanol or 1-propanol and the water-soluble acid is acetic acid.

5. The composition of claim 4 wherein said polyvinyl alcohol is at least 87 percent hydrolyzed.

6. The coating composition of claim 5 wherein said solvating amount of lower aliphatic alcohol represents up to about 40 weight percent of the coating composition.

7. The coating composition of claim 3 wherein the pH of said coating composition is from about 4 to about 5.

8. The coating composition of claim 2 wherein the composition also includes from about 1 to about 10 weight percent of fluorinated silane.

9. The coating composition of claim 8 wherein said fluorinated silane is present in an amount of from about 1 to about 5 weight percent.

10. The coating composition of claim 9 wherein said fluorinated silane is 3,3,3-trifluoropropyltrimethoxysilane.

11. A coating composition consisting essentially of:
(a) from about 20 to about 70 weight percent of a silane monomer mixture of (i) a first silane monomer which is a glycidoxy(C₁-C₃)alkyl(C₁-C₂)ₐ alkyl(C₁-C₂)_{b} alkoxysilane wherein a is an integer of from 0 to 2 and b is the integer 2 or 3, provided that b is 3 only when a is 0 or 1, and (ii) a second silane monomer having the general formula (X)_{c}(C₁-C₃)_{d}alkyl(C₁-C₃)ₑalkyl(R¹)_{f}Si_{4-(d+e+f)}, wherein X is selected from the group consisting of mercapto, amino, chloro and methacryloxy, R¹ is C₁-C₄ alkoxy or acetoxy, and c and d are each the integers 0 or 1, e is the integer 1 or 2, and f is the integer 2 or 3, the weight ratio of (i):(ii) being from about 1:7 to about 1:15;
(b) a binding amount of silane monomer-compatible water-soluble organic polymer;
(c) a leveling amount of nonionic surfactant;
(d) a solvating amount of lower aliphatic alcohol;
(e) a catalytic amount of water-soluble acid; and
(f) water in an amount sufficient to form hydrolysates of said silane monomers and to solubilize said water-soluble polymer and acid.

12. The coating composition of claim 11 wherein the amount of the silane monomer mixture is from about 20 to to about 55 weight percent, the weight ratio of (i):(ii) is from about 1:7 to about 1:10; the water-soluble polymer is selected from the group consisting of hydroxyethyl cellulose, polyvinyl alcohol, and polyvinyl pyrrolidone and is present in an amount of from about 1 to about 8 weight percent; said nonionic surfactant is selected from the group consisting of alkyl phenol ethoxylates, fluoroaliphatic polymeric esters and fluorinated alkyl polyoxyethylene ethanols; and the lower aliphatic alcohol is C₁-C₃ alkanol or aliphatic alcohol of the formula [(R³)ᵢR⁴]ⱼ(C₁-C₃)OH, wherein R³ and R⁴ are each C₁-C₂ alkoxy, i is the integer 0 or 1, and j is the integer 1.

13. The coating composition of claim 12 wherein the amount of the silane monomer mixture is from about 20 to 45 weight percent; the lower aliphatic alcohol is selected from the group consisting of methanol, ethanol, 1-propanol and 1-methoxy-2-propanol; and the water-soluble acid is acetic acid or nitric acid.

14. The coating composition of claim 11 wherein the composition also includes from about 1 to about 10 weight percent of fluorinated silane.

15. The coating composition of claim 14 wherein said fluorinated silane is present in an amount from about 1 to about 5 weight percent.

16. A process for preparing an antireflective coating on an organic polymeric host material comprising the steps of:
(a) coating said polymeric host with a transparent durable coating composition, (b) curing said coating composition;
(c) treating the cured coating with an aqueous acidic solution comprising from about 0.5 to 3 weight percent hydrofluoric acid, and from about 0 to 1.0 weight percent nitric acid for a time sufficient to produce a coating having a graded refractive index;
(d) contacting the cured coating of step (c) with an aqueous alkaline leaching solution for a time sufficient to remove residual acid from the surface of the coating; and
(e) drying and further curing the coating of step (d).

17. The process of claim 16 wherein a nonionic fluorosurfactant is present in the aqueous acidic solution; said aqueous alkaline leaching solution is an aqueous alkaline solution comprising tetra(C₁-C₄)alkylammonium hydroxide and nonionic fluorosurfactant; and the organic polymeric host material is selected from the group consisting of poly(C₁-C₁₂ alkyl methacrylates), poly(oxyalkylene dimethacrylates), poly(alkoxylated phenol methacrylates), cellulose acetate, cellulose triacetate, cellulose acetate propionate, cellulose acetate butyrate, poly(vinyl acetate), poly(vinyl alcohol), poly(vinyl chloride), poly(vinylidene chloride), thermoplastic polycarbonates, polyesters, polyurethanes, poly(ethylene terephthalate), polystyrene, poly(alpha methylstyrene), copoly(styrene-methylmethacrylate), copoly(styrene-acrylonitrile), polyvinylbutyral and polymers of members of the group consisting of polyol(allyl carbonate) monomers, polyfunctional acrylate monomers, polyfunctional methacrylate monomers, diethylene glycol dimethacrylate monomers, diisopropenyl benzene monomers, ethoxylated bisphenol A dimethacrylate monomers, ethylene glycol bismethacrylate monomers, poly(ethylene glycol) bismethacrylate monomers, ethoxylated phenol methacrylate monomers, alkoxylated polyhydric alcohol acrylate monomers and diallylidene pentaerythritol monomers.

18. The process of claim 17 wherein said nonionic fluorosurfacant is fluorinated alkylpolyoxyethylene ethanol, and said organic polymeric host material is a solid transparent homopolymer or copolymer selected from the group consisting of poly(methyl methacrylate), poly(ethylene glycol bismethacrylate), poly(ethoxylated bisphenol A dimethacrylate), thermoplastic polycarbonate, poly(vinyl acetate), polyvinylbutyral, polyurethane and polymers of members of the group consisting of diethylene glycol bis(allyl carbonate) monomers, diethylene glycol dimethacrylate monomers, ethoxylated phenol methacrylate monomers, diisopropenyl benzene monomers and ethoxylated trimethylol propane triacrylate monomers.

19. A process for preparing an antireflective coating on an organic polymeric host material comprising the steps of:
(a) applying to said polymeric host a coating composition consisting essentially of:
(1) about 20 to 70 weight percent of a silane monomer mixture of (i) a first silane monomer which is a glycidoxy(C₁-C₃)alkyl(C₁-C₂)ₐ alkyl(C₁-C₂)b alkoxysilane, wherein a is an integer of from 0 to 2 and b is the integer 2 or 3, provided that b is 3 only when a is 0 or 1, and (ii) a second silane monomer having the general formula (X)_{c}(C₁-C₃)_{d}alkyl(C₁-C₃)ₑalkyl(R¹)_{f}Si_{4-(d+e+f)}, wherein X is selected from the group consisting of mercapto, amino, chloro and methacryloxy, R¹ is C₁-C₄ alkoxy or acetoxy, and c and d are each the integers 0 or 1, e is the integer 1 or 2, and f is the integer 2 or 3, the weight ratio of (i):(ii) being from about 1:3 to 1:20;
(2) from about 1 to 40 weight percent of tetra(C₁-C₄)alkoxysilane;
(3) a binding amount of silane monomer-compatible water-soluble organic polymer;
(4) a leveling amount of nonionic surfactant;
(5) a solvating amount of lower aliphatic alcohol;
(6) a catalytic amount of water-soluble acid; and
(7) water in an amount sufficient to form hydrolysates of said silane monomers and to solubilize said water-soluble polymer and acid;
(b) curing said coating composition;
(c) treating the cured coating with an aqueous acidic solution comprising from about 0.5 to 3 weight percent hydrofluoric acid, and from about 0 to 1.0 weight percent nitric acid for a time sufficient to produce a coating having a graded refractive index;
(d) contacting the treated coating of step (c) with an aqueous alkaline leaching solution for a time sufficient to remove residual acid from the surface of the coating; and
(e) drying and further curing the coating of step (d).

20. The process of claim 19 wherein a nonionic fluorosurfactant is present in the aqueous acidic solution; said aqueous alkaline leaching solution is an aqueous alkaline solution comprising tetra(C₁-C₄)alkylammonium hydroxide and nonionic fluorosurfactant; and the organic polymeric host material is selected from the group consisting of poly(C₁-C₁₂ alkyl methacrylates), poly(oxyalkylene dimethacrylates), poly(alkoxylated phenol methacrylates), cellulose acetate, cellulose triacetate, cellulose acetate propionate, cellulose acetate butyrate, poly(vinyl acetate), poly(vinyl alcohol), poly(vinyl chloride), poly(vinylidene chloride), thermoplastic polycarbonates, polyesters, polyurethanes, poly(ethylene terephthalate), polystyrene, poly(alpha methylstyrene), copoly(styrene-methylmethacrylate), copoly(styrene-acrylonitrile), polyvinylbutyral and polymers of members of the group consisting of polyol(allyl carbonate) monomers, polyfunctional acrylate monomers, polyfunctional methacrylate monomers, diethylene glycol dimethacrylate monomers, diisopropenyl benzene monomers, ethoxylated bisphenol A dimethacrylate monomers, ethylene glycol bismethacrylate monomers, poly(ethylene glycol) bismethacrylate monomers, ethoxylated phenol methacrylate monomers, alkoxylated polyhydric alcohol acrylate monomers and diallylidene pentaerythritol monomers.

21. The process of claim 20 wherein said nonionic fluorosurfacant is fluorinated alkylpolyoxyethylene ethanol, and said organic polymeric host material is a solid transparent homopolymer or copolymer selected from the group consisting of poly(methyl methacrylate), poly(ethylene glycol bismethacrylate), poly(ethoxylated bisphenol A dimethacrylate), thermoplastic polycarbonate, poly(vinyl acetate), polyvinylbutyral, polyurethane and polymers of members of the group consisting of diethylene glycol bis(allyl carbonate) monomers, diethylene glycol dimethacrylate monomers, ethoxylated phenol methacrylate monomers, diisopropenyl benzene monomers and ethoxylated trimethylol propane triacrylate monomers.

22. The process of claim 20 wherein the amount of the silane monomer mixture is from about 20 to 55 weight percent, the weight ratio of (i):(ii) is from about 1:4 to about 1:15; the amount of tetra(C₁-C₄)alkoxysilane is from about 2 to about 20 weight percent; the water-soluble polymer is selected from the group consisting of hydroxyethyl cellulose, polyvinyl alcohol, and polyvinyl pyrrolidone and is present in an amount of from about 1 to 8 weight percent; said nonionic surfactant is selected from the group consisting of alkyl phenol ethoxylates, fluoroaliphatic polymeric esters and fluorinated alkyl polyoxyethylene ethanol; and the lower aliphatic alcohol is a C₁-C₃ alkanol or aliphatic alcohol of the formula [(R³)ᵢR⁴]ⱼ(C₁-C₃)OH, wherein R³ and R⁴ are each C₁-C₂ alkoxy, i is the integer 0 or 1, and j is the integer 1.

23. The process of claim 22 wherein the amount of the silane monomer mixture is from about 20 to 45 weight percent, the weight ratio of (i):(ii) is from about 1:7 to about 1:15; the amount of tetra(C₁-C₄)alkoxysilane is from about 2 to about 10 weight percent; the lower aliphatic alcohol is selected from the group consisting of methanol, ethanol, 1-propanol and 1-methoxy-2-propanol, and the water-soluble acid is acetic acid or nitric acid;

24. The process of claim 23 wherein the first silane monomer is gamma-glycidoxypropyltrimethoxysilane, gamma-glycidoxypropylmethyldimethoxysilane, gamma-glycidoxypropyldimethylethoxysilane, hydrolysates thereof, or mixtures of such silane monomers and the second silane monomer is methyltrimethoxysilane, methyltriethoxysilane, ethyltrimethoxysilane, ethyltriethoxysilane, hydrolysates thereof or mixtures of such silane monomers; the water-soluble polymer is a polyvinyl alcohol that is at least 72 percent hydrolyzed; the nonionic surfactant is a fluoroaliphatic polymeric ester; the lower aliphatic alcohol is methanol, ethanol or 1-propanol and the water-soluble acid is acetic acid.

25. The process of claim 24 wherein said polyvinyl alcohol is at least 87 percent hydrolyzed.

26. The process of claim 19 wherein said coating composition includes also from about 1 to about 10 weight percent of fluorinated silane.

27. The process of claim 26 wherein said fluorinated silane is from about 1 to about 5 weight percent.

28. A process for preparing an antireflective coating on an organic polymeric host material comprising the steps of:
(a) applying to said polymeric host a coating composition consisting essentially of:
(1) about 20 to 70 weight percent of a silane monomer mixture of (i) a first silane monomer which is a glycidoxy(C₁-C₃)alkyl(C₁-C₂)ₐ alkyl(C₁-C₂)_{b} alkoxysilane, wherein a is an integer of from 0 to 2 and b is the integer 2 or 3, provided that b is 3 only when a is 0 or 1, and (ii) a second silane monomer having the general formula (X) _{c}(C₁-C₃)_{d}alkyl(C₁-C₃)ₑalkyl(R¹)_{f}Si_{4-(d+e+f)}, wherein X is selected from the group consisting of mercapto, amino, chloro and methacryloxy, R¹ is C₁-C₄ alkoxy or acetoxy, and c and d are each the integers 0 or 1, e is the integer 1 or 2, and f is the integer 2 or 3, the weight ratio of (i):(ii) being from about 1:4 to 1:15;
(2) a binding amount of silane monomer-compatible water-soluble organic polymer;
(3) a leveling amount of nonionic surfactant;
(4) a solvating amount of lower aliphatic alcohol;
(5) a catalytic amount of water-soluble acid; and
(6) water in an amount sufficient to form hydrolysates of said silane monomers and to solubilize said water-soluble polymer and acid;
(b) curing said coating composition;
(c) treating the cured coating with an aqueous acidic solution comprising from about 0.5 to 3 weight percent hydrofluoric acid, and from about 0 to 1.0 weight percent nitric acid for a time sufficient to produce a coating having a graded refractive index;
(d) contacting the treated coating of step (c) with an aqueous alkaline leaching solution for a time sufficient to remove residual acid from the surface of the coating; and
(e) drying and further curing the coating of step (d).

29. The process of claim 28 wherein a nonionic fluorosurfactant is present in the aqueous acidic solution; said aqueous alkaline leaching solution is an aqueous alkaline solution comprising tetra(C₁-C₄)alkylammonium hydroxide and nonionic fluorosurfactant; and the organic polymeric host material is selected from the group consisting of poly(C₁-C₁₂ alkyl methacrylates), poly(oxyalkylene dimethacrylates), poly(alkoxylated phenol methacrylates), cellulose acetate, cellulose triacetate, cellulose acetate propionate, cellulose acetate butyrate, poly(vinyl acetate), poly(vinyl alcohol), poly(vinyl chloride), poly(vinylidene chloride), thermoplastic polycarbonates, polyesters, polyurethanes, poly(ethylene terephthalate), polystyrene, poly(alpha methylstyrene), copoly(styrene-methylmethacrylate), copoly(styrene-acrylonitrile), polyvinylbutyral and polymers of members of the group consisting of polyol(allyl carbonate) monomers, polyfunctional acrylate monomers, polyfunctional methacrylate monomers, diethylene glycol dimethacrylate monomers, diisopropenyl benzene monomers, ethoxylated bisphenol A dimethacrylate monomers, ethylene glycol bismethacrylate monomers, poly(ethylene glycol) bismethacrylate monomers, ethoxylated phenol methacrylate monomers, alkoxylated polyhydric alcohol acrylate monomers and diallylidene pentaerythritol monomers.

30. The process of claim 29 wherein said nonionic fluorosurfacant is fluorinated alkylpolyoxyethylene ethanol, and said organic polymeric host material is a solid transparent homopolymer or copolymer selected from the group consisting of poly(methyl methacrylate), poly(ethylene glycol bismethacrylate), poly(ethoxylated bisphenol A dimethacrylate), thermoplastic polycarbonate, poly(vinyl acetate), polyvinylbutyral, polyurethane and polymers of members of the group consisting of diethylene glycol bis(allyl carbonate) monomers, diethylene glycol dimethacrylate monomers, ethoxylated phenol methacrylate monomers, diisopropenyl benzene monomers and ethoxylated trimethylol propane triacrylate monomers.

31. The process of claim 28 wherein the amount of the silane monomer mixture is from about 20 to 55 weight percent, the weight ratio of (i):(ii) is from about 1:7 to about 1:10; the water-soluble polymer is selected from the group consisting of hydroxyethyl cellulose, polyvinyl alcohol, and polyvinyl pyrrolidone and is present in an amount of from about 1 to 8 weight percent; said nonionic surfactant is selected from the group consisting of alkyl phenol ethoxylates, fluoroaliphatic polymeric esters and fluorinated alkyl polyoxyethylene ethanol; and the lower aliphatic alcohol is a C₁-C₃ alkanol or aliphatic alcohol of the formula [(R³)ᵢR^{4]}ⱼ(C₁-C₃)OH, wherein R³ and R⁴ are each C₁-C₂ alkoxy, i is the integer 0 or 1, and j is the integer 1.

32. The process of claim 31 wherein the amount of the silane monomer mixture is from about 20 to 45 weight percent; the lower aliphatic alcohol is selected from the group consisting of methanol, ethanol, 1-propanol and 1-methoxy-2-propanol, and the water-soluble acid is acetic acid or nitric acid;

33. An article comprising, in combination, an organic polymeric host material and on at least one surface thereof the cured coating composition of claim 1.

34. The article of claim 33 wherein the article is an optical element and the coating is antireflective.

35. The article of claim 34 wherein said optical element has a visible light transmission of greater than about 95 percent and percent haze of not more than about 0.5.

36. The article of claim 35 wherein said optical element is an ophthalmic lens.

37. An article comprising, in combination, an organic polymeric host material and on at least one surface thereof the cured coating composition of claim 8.

38. An article comprising, in combination, an organic polymeric host material and on at least one surface thereof the cured coating composition of claim 11.

39. An article comprising, in combination, an organic polymeric host material and on at least one surface thereof the cured coating composition of claim 14.

40. An article comprising, in combination, an organic polymeric host material and on at least one surface thereof an antireflective coating prepared by the process of claim 16.

41. An article comprising, in combination, an organic polymeric host material and on at least one surface thereof an antireflective coating prepared by the process of claim 19.

42. An article comprising, in combination, an organic polymeric host material and on at least one surface thereof an antireflective coating prepared by the process of claim 28.

43. A photochromic article comprising, in combination, an organic polymeric host material, a photochromic amount of at least one organic photochromic compound associated with said host material, and on at least one surface thereof the cured coating composition of claim 1.

44. The photochromic article of claim 43 wherein said organic polymeric host material is a solid transparent homopolymer or copolymer selected from the group consisting of poly(methyl methacrylate), poly(ethylene glycol bismethacrylate), poly(ethoxylated bisphenol A dimethacrylate), thermoplastic polycarbonate, poly(vinyl acetate), polyvinylbutyral, polyurethane and polymers of members of the group consisting of diethylene glycol bis(allyl carbonate) monomers, diethylene glycol dimethacrylate monomers, ethoxylated phenol methacrylate monomers, diisopropenyl benzene monomers and ethoxylated trimethylol propane triacrylate monomers.

45. The photochromic article of claim 44 wherein the article is an optical element.

46. The photochromic article of claim 45 wherein the cured coating is antireflective.

47. The photochromic article of claim 46 wherein the article is an ophthalmic lens.

48. A photochromic article comprising, in combination, an organic polymeric host material, a photochromic amount of at least one organic photochromic compound associated with said host material, and on at least one surface thereof the cured coating composition of claim 11.

49. A photochromic article comprising, in combination, an organic polymeric host material, a photochromic amount of at least one organic photochromic compound associated with said host material, and on at least one surface thereof an antireflective coating prepared by the process of claim 19.

50. A photochromic article comprising, in combination, an organic polymeric host material, a photochromic amount of at least one organic photochromic compound associated with said host material, and on at least one surface thereof an antireflective coating prepared by the process of claim 28.
